(19) United States
(12) Patent Application Publication
(10) Pub. No.: US 2015/0100476 A1
(43) Pub. Date: Apr. 9, 2015

(54) COMPUTER-BASED METHOD FOR MAKING AN IN-GAME PURCHASE FROM AN INDEPENDENT ELECTRONIC DATA PROCESSING UNIT

(71) Applicant: Xsolla (USA) Inc., Sherman Oaks, CA (US)

(72) Inventor: Aleksandr Agapitov, Sherman Oaks, CA (US)

(73) Assignee: Xsolla (USA) Inc., Sherman Oaks, CA (US)

(21) Appl. No.: 14/047,703

(22) Filed: Oct. 7, 2013

(51) Int. Cl. G06Q 20/12

(52) U.S. Cl. CPC G06Q 20/123
USPC 705/39

(57) ABSTRACT

A computer-based method for making an in-game purchase from an independent electronic data processing unit. The computer-based method may comprise the steps of: providing a server application configured to run on a server, a first application configured to run on a first electronic data processing unit, and a second application configured to run on a second electronic data processing unit. The first application and the second application may be configured to access the server application online. The first electronic data processing unit may be configured to allow a user to play an online game. The second application preferably allows the user to purchase an in-game feature for the first application by making one or more payments in the second application, and the user preferably sends a payment through the second application. The server application preferably receives the payment from the user, and the second application may be an in-game payment application.

### FIELD OF THE INVENTION

The present invention generally relates to payments methods for online videogames, and more particularly, the invention generally relates to a method for making an in-game purchase using an independent electronic device while the user is able to continue playing the game for which the purchase is made.

### BACKGROUND OF THE INVENTION

In recent years, the Internet has enabled an explosion of online electronic gaming, including multi-player gaming. Like most industries, the gaming industry has continued to be network-friendly and has generally enabled players to participate in gaming events from their personal computers and in various regions. As a result, Internet or online gaming has become an extremely popular activity, resulting with numerous users logging into gaming sites and virtual reality worlds and participating in various games from their personal computers and game consoles.

One major facet of online gaming, and a source of revenue for the game provider, is performing an in-game purchase. Game developers provide a variety of electronic additions and expansions to their online games. Frequently, online gamers can acquire these electronic additions to their games by making online payments. In-game purchasing became particularly popular following the 2005-2006 launch releases of online gaming marketplaces, such as Xbox Live® Marketplace, that offered numerous in-game purchases for online games running on the same platform. In-game purchasing is now common to online games.

Many in-game purchases are accomplished through an online marketplace, which is outside of the confines of the game itself. For example, a user interested in acquiring an addition to his or her game can visit an online marketplace through a website or through that specific gaming platform. A user typically connects to an online marketplace directly from a game by following a link provided by the game or by pushing an action button in the game that connects him or her to the online marketplace. The user may be required to provide a username and password to his or her gaming account upon entering the marketplace or making a purchase. The user may then selects his or her purchase and method of online payment and then processes the payment online. While there have been variations of these payment methods, the basic methods of online payment have not changed much since the advent of credit cards and online banking such as Paypal®.

Other in-game purchases may be performed directly in the online game itself. For example, a user may log into the online game using his or her gaming account username and password. During the game session, the user generally selects his or her purchase. A pop-up window may then appear, or the user is usually redirected to another window menu where the user selects a method of online payment. Upon entering the new window, the user then processes the payment online. During the purchase, the user and the user's avatar, are typically suspended from play.

Most conventional online payment methods, however, are generally limited. Specifically, current online payment options are generally restricted to credit cards or PayPal®, and usually fail to offer payment options by mobile phone, debit card, or a bank account. Additionally, conventional in-game purchase methods exit or temporarily suspend a gamer's active game session, while the purchase is completed. Thus, in order to return to a game session after completing an in-game purchase, a gamer may be required to proceed through a game start menu or wait for a purchase window to close. Furthermore, conventional in-game purchase methods may require access to a personal computer or to a gaming console, which generally does not offer gamers the option to complete an in-game purchase when the gamers are playing from a mobile device.

Therefore, what is needed is a method for accomplishing in-game purchases independent from the online gaming platform. Preferably, the method will utilize a smartphone or equivalent mobile device.

### SUMMARY OF THE INVENTION

To minimize the limitations in the prior art, and to minimize other limitations that will become apparent upon reading and understanding the present specification, the present invention discloses a new and useful computer-based method for in-game purchasing using an independent mobile device.

One embodiment of the new method is computer-based method for performing an in-game purchase from an independent electronic data processing unit, the steps comprising: providing a server application, a first application, and a second application; wherein the server application is configured to run on a server; wherein the first application is configured to run on a first electronic data processing unit; wherein the second application is configured to run on a second electronic data processing unit; wherein the first application and the second application are configured to access the server application through a network; allowing the user to purchase an in-game feature for the first application by making one or more payments in the second application; sending the one or more payments by the second application to the server application; and receiving the one or more payments for the in-game feature by the server application. The first application of the first electronic data processing unit may be an online game configured to be played by a user; wherein the first electronic data processing unit is a gaming console. The second application of the second electronic data processing unit may be an in-game payment application. The second application may allow the user to choose and select the in-game feature for the first application. The computer-based method may further comprise the step of: validating the receiving step of the one or more payments for the in-game feature by the server application. The user may be associated with the at least one gaming account; and wherein the in-game feature may be linked to the at least one gaming account after the user purchases the in-game feature. The server application may store an account information of the at least gaming account; and wherein the second application may access the account information of the at least one gaming account when the user provides the one or more payments via the second application of the second electronic data processing unit. The second application may be associated with a billing account of the user, such that the user makes the one or more payments with the billing account. The in-game feature may be selected from the group of in-game features consisting of: an in-game resource and a character upgrade. The second electronic data processing unit may be a mobile computing device; and wherein the mobile computing device may be selected from the group of mobile computing devices consisting of: a smartphone, a laptop, and a tablet computer.

Another embodiment of the new method is a computer-based method for performing an in-game purchase from an independent electronic data processing unit, the steps comprising: providing a server application, a first application, and a second application; wherein the server application is configured to run on a server; wherein the first application is configured to run on a first electronic data processing unit; wherein the second application is configured to run on a second electronic data processing unit; wherein the first application and the second application are configured to access the server application through a network; wherein the first application of the first electronic data processing unit is an online game configured to be played by a user; wherein the second application of the second electronic data processing unit is an in-game payment application; allowing the user to purchase an in-game feature for the online game by making one or more payments in the in-game payment application; sending the one or more payments by the in-game payment application to the server application; and receiving the one or more payments for the in-game feature by the server application. The first electronic data processing unit may be a gaming console. The user may be associated with at least one gaming account; wherein the in-game feature may be linked to the at least one gaming account after the user purchases the in-game feature. The in-game payment application may be associated with a billing account of the user, such that the user makes the one or more payments with the billing account. The in-game payment application may allow the user to choose and select the in-game feature for the first application. The computer-based method may further comprise the step of: validating the receiving step of the one or more payments for the in-game feature by the server application. The server application may store an account information of the at least gaming account; wherein the in-game payment application accesses the account information of the at least one gaming account when the user provides the one or more payments via the in-game payment application of the second electronic data processing unit. The in-game feature may be selected from the group of in-game features consisting of: an in-game resource and a character upgrade. The second electronic data processing unit may be a mobile computing device; and wherein the mobile computing device may be selected from the group of mobile computing devices consisting of: a smartphone, a laptop, and a tablet computer.

Another embodiment of the new method is a computer-based method for performing an in-game purchase from an independent electronic data processing unit, the steps comprising: providing a server application, a first application, and a second application; wherein the server application is configured to run on a server; wherein the first application is configured to run on a first electronic data processing unit; wherein the second application is configured to run on a second electronic data processing unit; wherein the first application and the second application are configured to access the server application through a network; wherein the first application of the first electronic data processing unit is an online game configured to be played by a user; wherein the second application of the second electronic data processing unit is an in-game payment application; wherein the first electronic data processing unit is a gaming console; wherein the second electronic data processing unit is a mobile computing device; wherein the in-game payment application of the mobile computing device is associated with a billing account of a user; allowing the user to purchase an in-game feature for the online game by making one or more payments in the in-game payment application; sending the one or more payments by the in-game payment application to the server application; receiving the one or more payments for the in-game feature by the server application; validating the receiving step of the one or more payments for the in-game feature by the server application; wherein the server application is associated with at least one gaming account; wherein the at least one of gaming account is associated with the online game of the gaming console; wherein the in-game payment application accesses the at least one gaming account when the user provides the one or more payments via the in-game payment application of the mobile computing device; wherein the user is associated with the at least one gaming account; wherein the in-game feature is linked to the at least one gaming account after the user purchases the in-game feature; wherein an account information of the at least one gaming account is stored in the server application; and wherein the in-game feature is selected from the group of in-game features consisting of: an in-game resource and a character upgrade.

It is an object of the new method to provide a computer-based method and system for making an in-game purchase from an independent electronic data processing unit. The computer-based method may be one or more software applications running on a server, an electronic data processing unit such as a computer or gaming console, and/or a mobile electronic device.

It is another object of the new method to provide a mobile software application that enables a purchase on an independent electronic data processing unit; wherein the purchase data is transmitted to the gaming platform through a cellular or Internet network.

It is another object of the new method to allow a user to choose and select one or more in-game features on an in-game application of a mobile software application.

It is another object of the new method to enable online gamers to provide in-game purchases in real-time without exiting or canceling their game session.

It is another object of the new method to enable online gamers to receive in-game features in real-time without or with minimal pop-ups, interruptions, or redirections from their game session.

It is another object of the new method to enable online gamers to make in-game purchases without having to access a different menu screen during the gameplay of that online game.

It is an object of the new method to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the computer-based method for making an in-game purchase from an independent electronic data processing unit.

FIG. 2 is a block diagram of one embodiment of an electronic data processing unit.

FIG. 3 is a system diagram of one embodiment of a system for making an in-game purchase from an independent electronic data processing unit.

FIG. 4 is a screenshot of one embodiment of the second application of the second electronic data processing unit and shows how a user may select an in-game feature.

FIG. 5 is a screenshot of another embodiment of the second application and shows the second application opening a popup window that prompts the user to confirm the purchasing of the in-game feature.

FIG. 6 is a screenshot of another embodiment of the second application and shows when a payment has been made by a user on the second application.

FIG. 7 is a screenshot of another embodiment of the second electronic data processing unit and shows how a user may select an in-game feature in the second electronic data processing unit.

FIG. 8 is a screenshot of another embodiment of the second electronic data processing unit and shows how a user may confirm a purchase of the in-game feature in the second electronic data processing unit.

FIG. 9 is a screenshot of another embodiment of the second electronic data processing unit and shows when a payment may have been made by a user on the second application of the second electronic data processing unit.

### DETAILED DESCRIPTION OF THE INVENTION

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the terms “computer”, “mobile computing device”, and “electronic data processing unit” generally refer to any device that processes information with an integrated circuit chip, including without limitation, mainframe computers, work stations, gaming consoles, servers, desktop computers, portable computers, laptop computers, and embedded computers. Furthermore, the term “mobile computing device” may refer to any wireless devices including cellular phones, tablet computers, personal digital assistants, digital media players, portable game players, and hand-held computers.

As used herein, the term “Internet” generally refers to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the terms “application”, “software”, or “software application” generally refer to any set of machine-readable instructions on a client machine, web interface, and/or computer system, that directs a computer's processor to perform specific steps, processes, or operations disclosed herein.

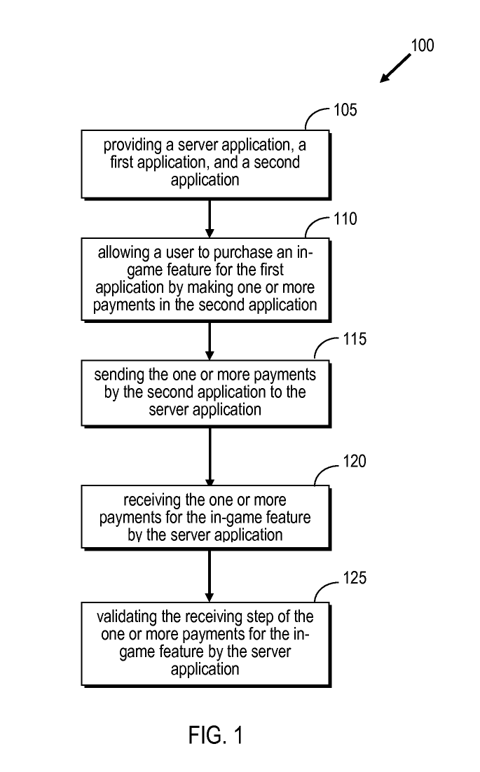

FIG. 1 is a flow chart of one embodiment of the computer-based method for making an in-game purchase from an independent electronic data processing unit. As shown in FIG. 1, one embodiment of the computer-based method 100 may comprise the computer-implemented steps of: providing a server application, a first application, and a second application 105; allowing a user to purchase an in-game feature for the first application by making one or more payments in the second application 110; sending the one or more payments by the second application to the server application 115; receiving the one or more payments for the in-game feature by the server application 120; and validating the receiving step of the one or more payments for the in-game feature by the server application 130.

FIG. 1 shows the first step of one embodiment of the computer-based method 100, which is preferably providing a server application, a first application, and a second application 105. The server application, first application, and second application are preferably any computer readable instructions that cause a processor to perform the methods and processes disclosed herein when the instructions are executed by the processor. The server application is preferably configured to run on a server and is generally configured to interact with the first application and second application. The first application is preferably configured to run on an electronic data processing unit or electronic computing device such as a computer system, gaming console, and/or mobile computing device and may be an online software or online game that communicates to the server application via a network such as the Internet. The first application may also be any interactive program such as a simulator, virtual life simulators, educational programs, puzzle programs, sandbox platforms, and multi-user domains (MUDs). The first application preferably has a user interface configured to receive or obtain one or more user inputs or parameters and is preferably configured to analyze data sent or received by the first electronic data processing unit. Additionally, the first application is preferably configured to run online video games and may include gaming user account information, which typically includes a username, password, settings, online/offline status indicator, gaming activity, and in-game purchase activity.

Similarly, the second application is preferably a software program with a user interface configured to receive or obtain one or more user inputs or parameters and may be configured to analyze data sent or received by the mobile computing device. Additionally, the second application is preferably configured to display the available in-game features for purchasing and to allow the user to select those in-game features for purchasing. The second application may also be configured to run on an electronic data processing unit or mobile computing device, and, in a preferred embodiment, the second application is preferably an in-game payment application. The second electronic data processing unit of the second application is preferably a smartphone, tablet computer, laptop, or cellphone and is preferably configured to communicate with the server application. Furthermore, the second application may be configured to allow a user to perform one or more purchases for the in-game features for the first application.

When a user is using the first application on the first electronic data processing unit such as playing a videogame, the user is preferably capable to make a purchase for an in-game feature for that game by using the second application. The second application may prompt the user to make that purchase by providing a tutorial walkthrough on the general accessibility of in-game purchases or display the details about the availability of a particular in-game purchase. Such in-game purchases may include, without limitation, an in-game resource such as purchasing equipment, items, weapons, character upgrades, character techniques, and the like. The in-game purchase may also be optional features in a game such as downloadable content (i.e., DLC content) and the purchasing of game packs, which may include additional characters, new levels, new environments, or new missions.

In various embodiments, the second application preferably allows the user to select in-game features for online games. For instance, the second application may be configured to launch a graphical user interface on a screen of the second electronic data processing unit. The user interface of the second application may display one or more dynamic lists of in-game features for purchasing along with information about the purchases, including description, price, and availability. The lists may also be displayed through various means including menus, sub-menus, tables, tabs, arrays, and windows. The user may also filter displays by searching or selecting display criteria, including purchase name, price range, description, and the like. Furthermore, the user preferably interacts with the user interface of the second application through buttons, check boxes, links, text fields, and scroll bars to navigate and make those selections. Although the user preferably chooses and selects such in-game features for purchasing in the second application, the method 100 may allow the user to choose and select such in-game features in the first application.

In another embodiment, the second application (e.g., in-game payment application) may be an online marketplace. For example, the second application may dynamically update the user interface and lists of in-game purchases using data from the first electronic data processing unit or second electronic data processing unit. The second electronic data processing unit may receive update data from a cellular network or Internet connection, but may also receive update data from device-to-device data transfer means, such as a wire cable or S Beam®, or from an external storage device, such as an external hard drive or Secure Digital Card (SD Card). The second electronic data processing unit may also be configured to check for and receive update data at scheduled intervals through tasks that have low processor requirements and/or run in the background of the second electronic data processing unit. The first electronic data processing unit and/or second electronic data processing unit may also receive update data from push technology. Furthermore, the second application may be configured to automatically locate update data on the second electronic data processing unit and apply the update data to the second application.

FIG. 1 also shows the second step of one embodiment of the computer-based method 100, which is allowing a user to purchase an in-game feature for the first application by making one or more payments in the second application 110. Here, after the user chooses the in-game feature that he or she would like to purchase, the second application preferably allows the user to make a purchase on that in-game feature in the second application. The second application may request from the user a user account login ID and password upon launch of the second application to ensure authorized application use and account security. The second application may also include various means for storing or associating mobile user, gaming user, and online payment account information, and the user may configure the second application to his or her preferred means for storing and associating the account information. These configurable preferences may include options to have the mobile application remember login identifications, login passwords, credit card numbers, and addresses, or to have the second application link the user with various online payment accounts. As such, the second application may aid in the organization, identification, and selection of in-game purchases. Other configurable preferences for the second application may comprise of interface ease-of-access settings, such as options to adjust font size, color, contrast, input method, security settings, security preferences, and scroll speed.

Once the user has access to use such payment account information, the user may make one or more payments through the second application through various payment methods. A payment method is generally defined as one or more payment mechanisms, systems, or payment services configured to allow a user to fund one or more projects (e.g., game or software applications), services, or goods, including without limitation online banks such as Paypal®, iTunes®, credit cards, debit cards, prepaid cards, bank accounts, and the like. The payment method is preferably provided by the second application, but may be provided from an electronic source such as database or server or any storage unit of the first electronic data processing unit such as an internal hard drive, external hard drive, computer readable mediums, the Internet, and the like.

Payment methods may include ‘buy now, pay later” options, so as to enable real-time purchasing without delays from payment processing, and such methods may require payment account information to be verified by the second application prior to purchasing. Further, the payment method may be chosen before the selections are made by the mobile user, after the selections are made by the mobile user, or upon initialization of the mobile application.

FIG. 1 shows the third step of the computer-based method 100, which is sending the one or more payments by the second application to the server application 115. After the user has made one or more payments through the second application of the second electronic data processing unit, the second application preferably sends the purchase data to the server. This typically involves sending the purchase data through a network such as the Internet and may require some acknowledgement by the server application that the payment has been received. Preferably, the purchase data is sent through the network through one or more encryption methods and preferably results with the second application acknowledging receipt of the purchase data to the user.

Finally, FIG. 1 shows the fourth and fifth steps of the computer-based method 100, which are receiving the one or more payments for the in-game feature by the server application 125 and validating the receiving step of the one or more payments for the in-game feature by the server application 130. The server application may receive the one or more payments from the second application after the user makes a purchase through the second electronic data processing unit. The purchase data may be stored on a server for the online game and may then be sent to the first electronic data processing unit for verification. The purchase data may be automatically enabled by the first electronic data processing unit, which may require the user to verify the payment process. For example, the recipient gaming user may be required to press an “accept” button before the first electronic data processing unit enables his in-game feature. If the recipient gaming user declines, the in-game purchase may be refunded. Alternatively, the server application alone may verify the in-game purchase without the approval or verification from the user via the first application. Although FIG. 1 shows five steps for the method 100, it should be understood that the method may comprise any number of steps without deviating from the scope of the invention.

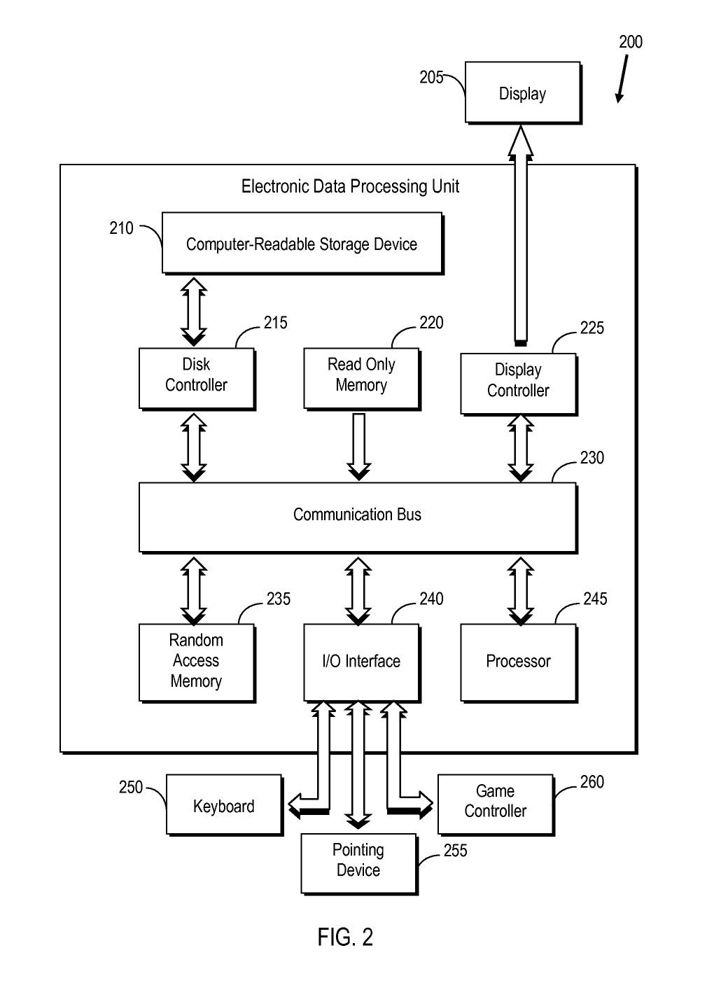

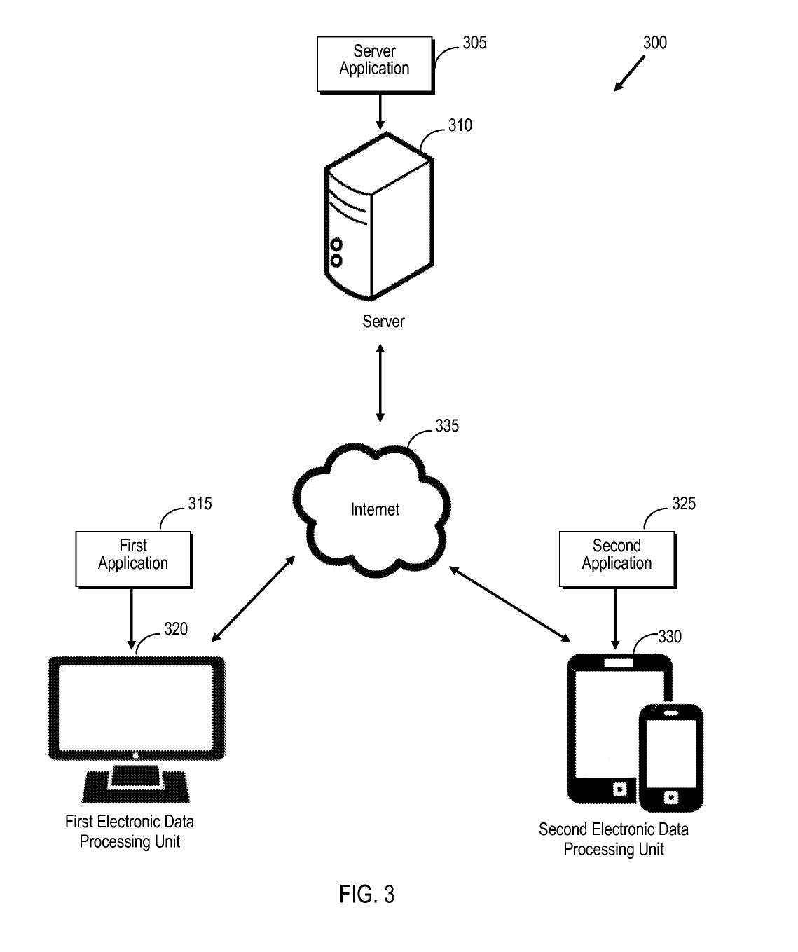

FIG. 2 is a block diagram of one embodiment of an electronic data processing unit. As shown in FIG. 2, one embodiment of an electronic data processing unit 200 may comprise: a display 205; computer-readable storage device 210; disk controller 215; read only memory (ROM) 220; display controller 225; communication bus 230; random access memory (RAM) 235; input/output interface (I/O interface) 240; processor 245; and one or more input devices, wherein the one or more input devices may comprise: a keyboard 250; pointing device 255; and/or game controller 260. In various embodiments, the electronic data processing unit 200 may be a personal computer, gaming console, or any mobile computing device that comprises a processor 245 connected through a communication bus 230, which preferably connects to other various electronic hardware, including without limitation, a display controller 225, RAM 235; ROM 220; disk controller 215; and I/O interface 240. The disk controller 215 is preferably configured to control the computer-readable storage device 210, which may be a hard drive and/or optical disk drive. The computer-readable storage device 210 may also be another form of computer memory without deviating from the scope of the invention. The display controller 225 is generally connected to the display 205 such as a liquid crystal display (LCD), projection system, or touchscreen. The electronic data processing unit may also have at least one display screen to display results to a user and may be any electronic visual display for computers and may include, without limitation, an liquid crystal display (LCD), cathode ray tube (CRT), light emitting diode (LED), and the like. The I/O interface 240 may be connected to one or more input devices such as a keyboard 250; pointing device 255; and/or game controller 260. In additional embodiments, the electronic data processing unit 200 may also comprise a network controller card connected through a network (shown in FIG. 3) such as the Internet or along an intranet. Indeed, those skilled in the art may recognize the advancements described herein are equally applicable to other known electronic hardware and that the above-noted computer hardware is exemplary only.

The processor 245 is preferably configured to execute a set of computer readable instructions and further to execute one or more applications or computer program as described herein such as the first application, the second application, or server application. The computer readable instructions and application may comprise instructions that cause the processor 245 to perform the methods disclosed herein and processes when the instructions are executed by the processor 245. In other various embodiments, the computer readable instructions or application may be tangibly embodied in the memory of the computer system such as the RAM 235 or ROM 220, as shown in FIG. 2, or on a computer-readable storage medium, such as a magnetic, optical or solid-state digital storage medium. The electronic data processing unit 200 may also include other components without deviating from the scope of the invention

FIG. 3 is a system diagram of one embodiment of a system for making an in-game purchase from an independent electronic data processing unit. As shown in FIG. 3, one embodiment of the system 300 may comprise: a server application 305; server 310; first application 315; first electronic data processing unit 320; second application 325; second electronic data processing unit 330; and Internet 335. The server application 305 is preferably one or more computer programs or software applications that cause the server to perform one or more tasks, including without limitation: (1) communicating with the first application 315 and second application 325; (2) receiving one or more payments from the user via the second application 325 of the second electronic data processing unit 330; (3) provide a gaming environment for the first application 315; (4) manage one or more gaming accounts of the users; (5) provide a second application 325 or in-game payment application for users to download; and (6) validating the payments received from the second application 325. The first application 315 is typically any software application, game, or online game that is configured to run on the first electronic data processing unit 320, which is preferably a computer or gaming console. In a preferred embodiment, the first application 315 is preferably an online game that is preferably configured to communicate with the server 310 and server application 305. The second application 325 is generally any software application such as an in-game payment application (e.g., in-game store application) that is configured to run on the second electronic data processing unit 330 and preferably allows a user to make in-game purchases through that second application 325. The second electronic data processing unit 330 may also be any independent mobile computing device such as a laptop, smartphone, and/or tablet computer. The Internet 335 is preferably a computer network consisting of a worldwide network of computer networks that use the TCP/IP network protocols to facilitate data transmission and exchange.

FIG. 3 also shows how a user may use one embodiment of the system to make an in-game purchase from the second electronic data processing unit. Specifically, a user may be utilizing the first application 315 of the first electronic data processing unit 320 such as playing an online game on a computer or gaming console. While playing that online game or navigating through the first application 315, the user may decide to purchase an in-game feature and preferably opens the second application 325 in his or her second electronic data processing unit 330 (e.g., smartphone, tablet computer, laptop, etc. . . . ). Once the second application 325 is open in the second electronic data processing unit 330, the user may search and select one or more in-game features for purchasing in the second application 325. The second application 325 may prompt the user to make a purchase for that in-game feature, and the user may then make an in-game purchase with the second electronic data processing unit 330 by first adding that in-game feature in a shopping cart and then completing the transaction by making a payment. The second application 325 may be an in-game payment application that is configured to link with the server 310 or server application 305 and may be associated with one or more billing accounts of the user to make those in-game purchases. The second application 325 then preferably sends the one or more payments to the server application 305, and the server application 305 preferably receives the one or more payments for the in-game features. Furthermore, the server application 305, first application 315, and/or second application 325 may validate the receipt of the payments for those in-game features. The server application 305 may be associated with a gaming account of the user, and the gaming account may be associated with the first application 315 of the first electronic data processing unit 320 or gaming console. The second application 325 may also be configured to accesses the gaming account when the user provides the payments via the second application 325 of the second electronic data processing unit 330. As discussed above, the in-game features may be an in-game resource such as character equipment and game items or the in-game features may be a character upgrade such as purchasing new skillsets, techniques, and experience points. The computer-based method 100 or system 300 may also allow a user to purchase new game packs or expansion packs via the second application 325.

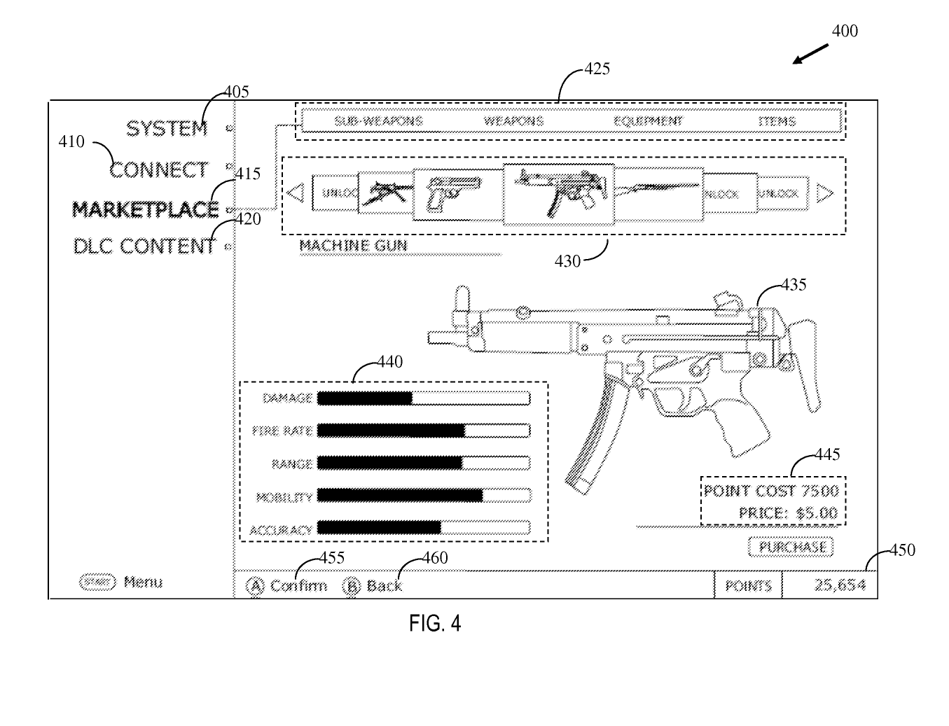

FIG. 4 is a screenshot of one embodiment of the second application of the second electronic data processing unit and shows how a user may select an in-game feature. Preferably, the second electronic data processing unit in this embodiment is a tablet computer. As shown in FIG. 4, one embodiment of the second application 400 may comprise: a system menu 405; connection menu 410; marketplace menu 415; downloadable content or DLC content menu 420; sub-menu 425; in-game feature display screen 430; in-game feature image 435; in-game feature attributes 440; in-game feature price 445; available credit 450; confirmation button 455; and back button 460. The system menu 405 preferably allows the user to access the configuration settings of the second application 400 and allow the user to change or confirm certain settings for the second application 400 and/or second electronic data processing unit. Such settings of the system menu 405 may comprise system settings, display settings, control settings, and the like. The connection menu 410 preferably allows the user to change or confirm certain network settings to allow the second application 325 to access or connect to the server 310. Such settings of the connection option 410 may comprise of setting the Internet Protocol (IP) address, allowing access of a user gaming account to the server 310; allowing the second application 400 or in-game payment application to access the server 310 and/or accessing the online gaming account of the user. The marketplace menu 415 preferably allows the user to view and access in-game features for purchasing, which may comprise of character upgrades, equipment, items, and the like. The DLC content menu 420 preferably allows a user to purchase DLC content such as aesthetic outfit changes, extensive storylines, expansion packs, new game modes, new objects, new levels, new game challenges, and/or other features to complete an already released game. The sub-menu 425 is preferably a secondary menu accessed from one or more general menus of the second application 400 or in-game payment application (e.g., system menu 405, connection menu 410, marketplace menu 415, DLC content menu 420) and preferably allows a user to select additional options from the general menus. For example, as shown in FIG. 4, the sub-menu 425 may be one or more subcategories of in-game features for purchasing in the marketplace (e.g., sub-weapons, weapons, equipment, items). The in-game feature display screen 430 is preferably a gallery, in which the user may have a glimpse of in-game features for purchasing such as equipment, character upgrades, and items. For example, as shown in FIG. 4, the in-game feature display screen 430 may comprise various images of weapons such as machine guns, automatics, rifles, pistols. The in-game feature image 435 is preferably one or more images of the in-game feature for purchasing and may provide more details about the in-game feature. The in-game feature attributes 440 preferably provides additional information about the in-game feature and may comprise of charts, graphs, tables, or additional description. The in-game feature price 445 preferably provides the pricing or costs of the in-game feature and may be expressed in units of currency such as United States dollars or units of points or credit. The available credit 450 is preferably the amount of credit available by the user and is generally the amount of credit available for the user to make a purchase for an in-game feature. The confirmation button 455 preferably allows the user to confirm the in-game purchase and the back button 460 is preferably used to allow the user to revert to the previous screen and/or cancel the purchase of the in-game feature.

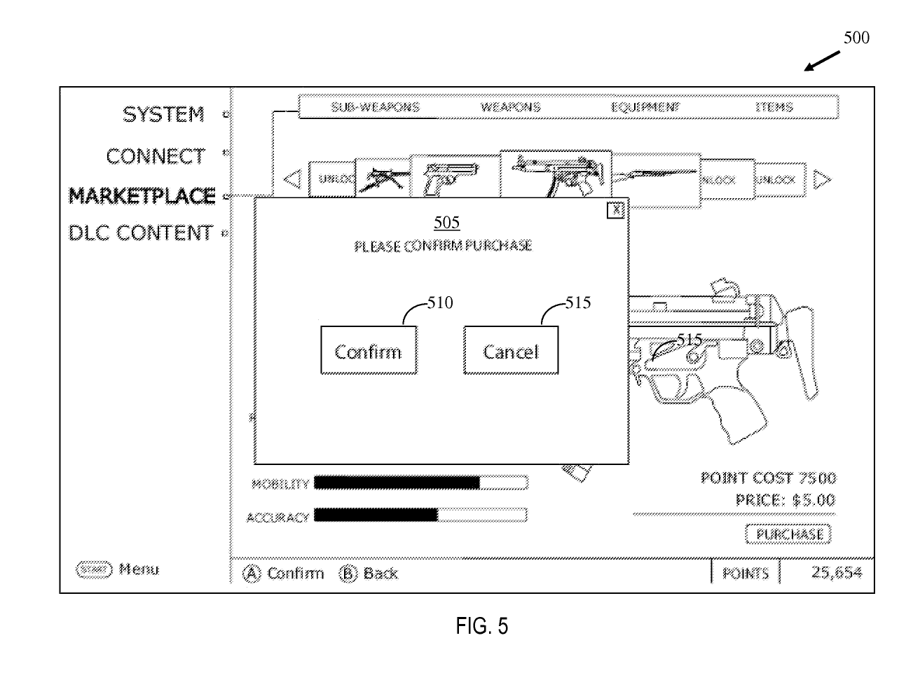

FIG. 5 is a screenshot of another embodiment of the second application and shows the second application opening a popup window that prompts the user to confirm the purchasing of the in-game feature. Like FIG. 4, the second electronic data processing unit in this embodiment is preferably a tablet computer. As shown in FIG. 5, another embodiment of the second application 500 may comprise: a purchasing confirmation window 505, confirm button 510, and cancel button 515. The purchasing confirmation window 505 may open in the second application 500 in response to an in-game feature purchase by the user. This generally allows the user to cancel or confirm the purchasing of the in-game feature in the second application 500. The purchasing confirmation window 505 may also prompt the user to purchase additional in-game features as well. The cancel button 515 is preferably configured to allow the user to cancel his or her in-game purchase in the second application 500. The confirm button 510 is preferably configured to allow the user to confirm his or her in-game purchase.

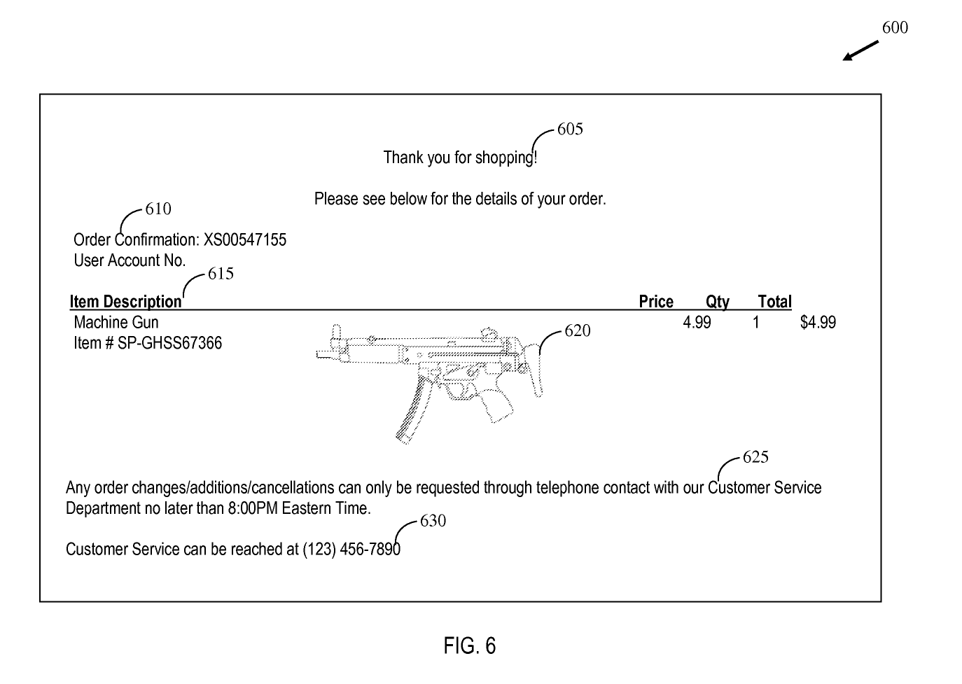

FIG. 6 is a screenshot of another embodiment of the second application and shows when a payment has been made by a user on the second application. Like FIGS. 4 and 5, the second electronic data processing unit in this embodiment is preferably a tablet computer. As shown in FIG. 6, another embodiment of the second application 600 may comprise: a confirmation message 605, confirmation number 610, item description 615, in-game feature image 620, additional information 625, and contact number 630. FIG. 6 shows that, after the user makes an in-game purchase on the second application 600, the second application 600 may display a confirmation message 605 that an order has been placed for a particular in-game feature or item. The confirmation message 605 may be supplemented by a confirmation number 610 for the order that was placed and an item description 615 to provide the user with a brief description of the in-game feature that was purchased. The second application 600 may also display an in-game feature image 620 and any additional information 625, such as how to cancel an order or make changes to a recent purchase. Finally, the second application, 600 may also provide the user with a contact number 630 to allow the user to contact a support team to provide any technical or administrative assistance.

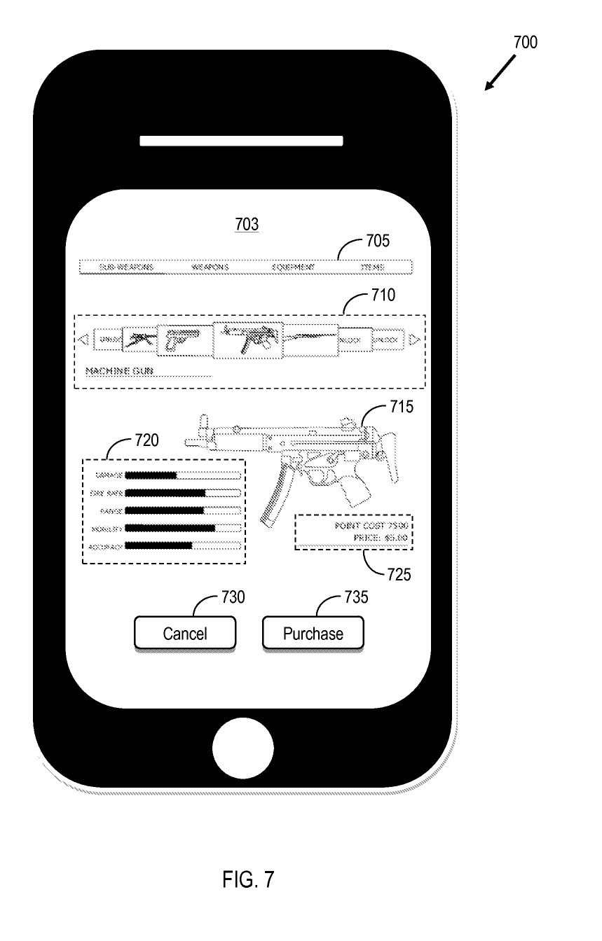

FIG. 7 is a screenshot of another embodiment of the second electronic data processing unit and shows how a user may select an in-game feature in the second electronic data processing unit. Preferably, the second electronic data processing unit 700 in this embodiment is a smartphone. As shown in FIG. 7, one embodiment of the second electronic data processing unit 700 may comprise: a second application 703, marketplace menu 705, in-game feature display screen 710, in-game feature image 715, in-game feature attributes 720, in-game feature price 725, cancel button 730, and purchase button 735. The marketplace menu 705 preferably allows the user to view and access in-game features for purchasing, which may comprise of character upgrades, equipment, items, and the like. The in-game feature display screen 710 is preferably a gallery, in which the user may have a glimpse of in-game features for purchasing such as equipment, character upgrades, and items. For example, as shown in FIG. 7, the in-game feature display screen 710 may comprise various images of weapons such as machine guns, automatics, rifles, pistols. The in-game feature image 715 is preferably one or more images of the in-game feature for purchasing and may provide more details about the in-game feature. The in-game feature attributes 720 preferably provides additional information about the in-game feature and may comprise of charts, graphs, tables, or additional description. The in-game feature price 725 preferably provides the pricing or costs of the in-game feature and may be expressed in units of currency such as United States dollars or units of points or credit. The purchase button 735 preferably allows the user to purchase the in-game feature and the cancel button 730 is preferably configured to cancel the current transaction for the purchase of the in-game feature.

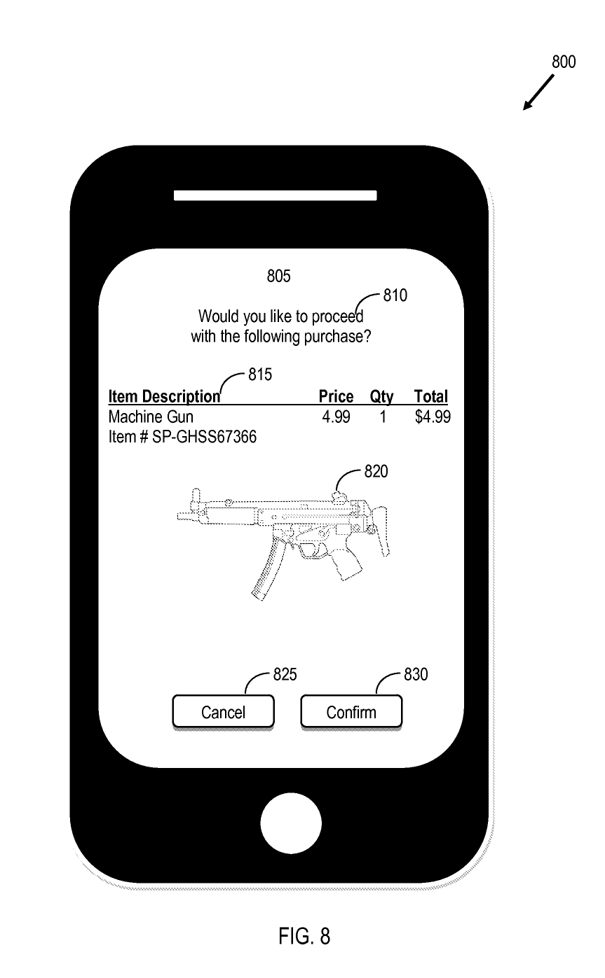

FIG. 8 is a screenshot of another embodiment of the second electronic data processing unit and shows how a user may confirm a purchase of the in-game feature in the second electronic data processing unit. Like FIG. 7, the second electronic data processing unit 800 in this embodiment is preferably a smartphone. As shown in FIG. 8, one embodiment of the second electronic data processing unit 800 may comprise: a second application 805, message 810, item description 815, item image 820, cancel button 825, and confirm button 830. As discussed above, a user may make an in-game purchase on a second application 805 running on the second electronic data processing unit 800. The second application 805 is preferably an in-game payment application, which may be downloaded from the server 310. The second electronic data processing unit 800 may be an independent mobile computing device such as a laptop, smartphone, or tablet computer.

When making an in-game purchase, the user may be prompted as to whether to confirm the purchase of that in-game feature by a message 810 displayed in the second application 805. The message 810 may comprise an item description 815 of the in-game feature such as the description of the in-game feature, price, and quantity. The item description 815 may also further comprise an image of that particular item (e.g., item image 820). If the user wishes to proceed with the purchase of that in-game feature, the user may select the confirm button 830. Otherwise, the user may select the cancel button 825 to cancel that purchase transaction.

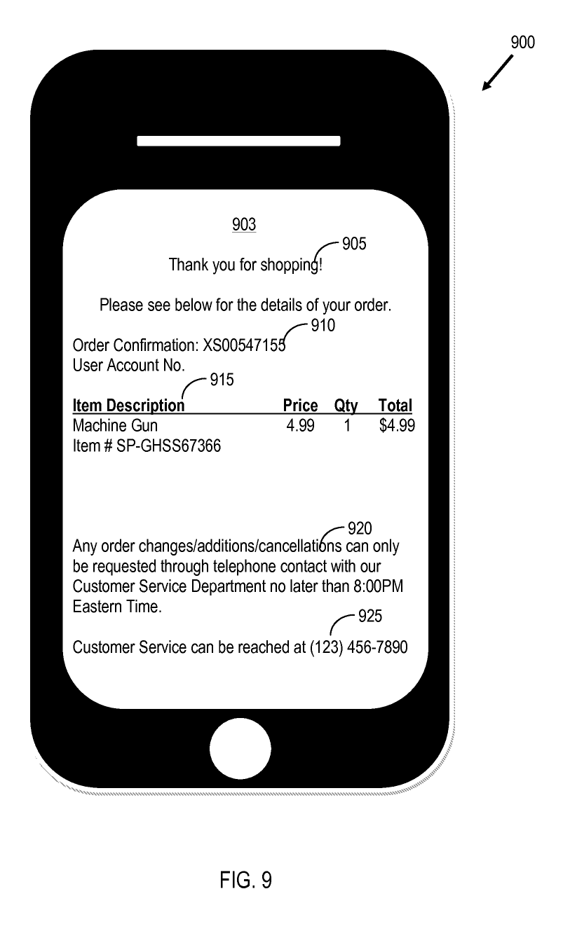

FIG. 9 is a screenshot of another embodiment of the second electronic data processing unit and shows when a payment may have been made by a user on the second application of the second electronic data processing unit. Like FIGS. 7 and 8, the second electronic data processing unit 900 in this embodiment is preferably a smartphone. As shown in FIG. 9, another embodiment of the second electronic data processing unit 900 may comprise: a second application 903; a confirmation message 905; confirmation number 910; item description 915; additional information 920; and contact number 925. FIG. 9 shows that, after the user makes an in-game purchase on the second application 903, the second application 903 may display a confirmation message 905 that an order has been placed for a particular in-game feature or item. The confirmation message 905 may be supplemented by a confirmation number 910 for the order that was placed and an item description 915 to provide the user with a brief description of the item that was purchased. The second application 903 may also display additional information 920 such as how to cancel an order or make changes to the recent purchases. Finally, the second application 903 may also provide the user with a contact number 925 to allow the user to contact a support team to provide any technical or administrative assistance.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method for performing an in-game purchase from an independent electronic data processing unit, the steps comprising:
providing a server application;
wherein said server application is configured to run on a server;
wherein a first application and a second application are configured to access said server application through a network;
wherein said first application is configured to run on a first electronic data processing unit;
wherein said second application is configured to run on a second electronic data processing unit;
wherein said first application is configured to prompt a user to purchase an in-game feature for said first application by making one or more payments in said second application;
wherein said second application is configured to send said one or more payments to said server application; and
receiving said one or more payments for said in-game feature by said server application.

2. The computer-based method of claim 1, wherein said first application of said first electronic data processing unit is an online game configured to be played by a user; and
wherein said first electronic data processing unit is a gaming console.

3. The computer-based method of claim 1, wherein said second application of said second electronic data processing unit is an in-game payment application.

4. The computer-based method of claim 1, wherein said second application is configured to allow said user to choose and select said in-game feature for said first application.

5. The computer-based method of claim 1, further comprising the step of:
validating said receiving step of said one or more payments for said in-game feature by said server application.

6. The computer-based method of claim 1, wherein said at least one gaming account is configured to be associated with said user; and
wherein said in-game feature is configured to be linked to said at least one gaming account after said user purchases said in-game feature.

7. The computer-based method of claim 6, wherein said server application stores an account information of said at least one gaming account; and
wherein said second application is configured to access said account information of said at least one gaming account when said one or more payments are received via said second application of said second electronic data processing unit.

8. The computer-based method of claim 1, wherein said second application is configured to be associated with a billing account of said user, such that said billing account is used to make said one or more payments.

9. The computer-based method of claim 1, wherein said in-game feature is selected from the group of in-game features consisting of: an in-game resource and a character upgrade.

10. The computer-based method of claim 1, wherein said second electronic data processing unit is a mobile computing device; and
wherein said mobile computing device is selected from the group of mobile computing devices consisting of: a smartphone, a laptop, and a tablet computer.

11. A computer-based method for performing an in-game purchase from an independent electronic data processing unit, the steps comprising:
providing a server application;
wherein said server application is configured to run on a server;
wherein a first application and a second application are configured to access said server application through a network;
wherein said first application is configured to run on a first electronic data processing unit;
wherein said second application is configured to run on a second electronic data processing unit;
wherein said first application of said first electronic data processing unit is an online game configured to be played by a user;
wherein said second application of said second electronic data processing unit is an in-game payment application;
wherein said first application is configured to prompt a user to purchase an in-game feature for said online game by making one or more payments in said in-game payment application;
wherein said in-game payment application is configured to send said one or more payments to said server application; and
receiving said one or more payments for said in-game feature by said server application.

12. The computer-based method of claim 11, wherein said first electronic data processing unit is a gaming console.

13. The computer-based method of claim 12, wherein at least one gaming account is configured to be associated with said user; and
wherein said in-game feature is configured to be linked to said at least one gaming account after said user purchases said in-game feature.

14. The computer-based method of claim 13, wherein said in-game payment application is configured to be associated with a billing account of said user, such that said billing account is used to make said one or more payments.

15. The computer-based method of claim 14, wherein said in-game payment application allows said user to choose and select said in-game feature for said first application.

16. The computer-based method of claim 15, further comprising the step of:
validating said receiving step of said one or more payments for said in-game feature by said server application.

17. The computer-based method of claim 16, wherein said server application stores an account information of said at least one gaming account;
wherein said in-game payment application is configured to access said account information of said at least one gaming account when said one or more payments are received via said in-game payment application of said second electronic data processing unit.

18. The computer-based method of claim 17, wherein said in-game feature is selected from the group of in-game features consisting of: an in-game resource and a character upgrade.

19. The computer-based method of claim 19, wherein said second electronic data processing unit is a mobile computing device; and
wherein said mobile computing device is selected from the group of mobile computing devices consisting of: a smartphone, a laptop, and a tablet computer.

20. A computer-based method for performing an in-game purchase from an independent electronic data processing unit, the steps comprising:
providing a server application;
wherein said server application is configured to run on a server;
wherein a first application and a second application are configured to access said server application through a network;
wherein said first application is configured to run on a first electronic data processing unit;
wherein said second application is configured to run on a second electronic data processing unit;
wherein said first application of said first electronic data processing unit is an online game configured to be played by a user;
wherein said second application of said second electronic data processing unit is an in-game payment application;
wherein said first electronic data processing unit is a gaming console;
wherein said second electronic data processing unit is a mobile computing device;
wherein said in-game payment application of said mobile computing device is associated with a billing account of a user;
wherein said first application is configured to prompt a user to purchase an in-game feature for said online game by making one or more payments in said in-game payment application;
wherein said in-game payment application is configured to send said one or more payments to said server application;
receiving said one or more payments for said in-game feature by said server application;
validating said receiving step of said one or more payments for said in-game feature by said server application;
wherein said server application is associated with at least one gaming account;
wherein said at least one of gaming account is associated with said online game of said gaming console;
wherein said in-game payment application accesses said at least one gaming account when said user provides said one or more payments via said in-game payment application of said mobile computing device;
wherein said at least one gaming account is configured to be associated with said user;
wherein said in-game feature is configured to be linked to said at least one gaming account-after said user purchases said in-game feature;
wherein an account information of said at least one gaming account is stored in said server application; and
wherein said in-game feature is selected from the group of in-game features consisting of: an in-game resource and a character upgrade.
